(19) United States
(12) Patent Application Publication
(10) Pub. No.: US 2014/0380472 A1
(43) Pub. Date: Dec. 25, 2014

(54) MALICIOUS EMBEDDED HYPERLINK DETECTION

(71) Applicant: LENOVO (Singapore) PTE. LTD., New Tech Park (SG)

(72) Inventors: Nathan J. Peterson, Durham, NC (US); John Carl Mese, Cary, NC (US); Russell Speight VanBlon, Raleigh, NC (US); Arnold S. Weksler, Raleigh, NC (US)

(21) Appl. No.: 13/925,515

(22) Filed: Jun. 24, 2013

(51) Int. Cl. H04L 29/06

(52) U.S. Cl. CPC H04L 63/1416
USPC 726/23

(57) ABSTRACT

For malicious embedded hyperlink detection, an identification module identifies an uncertain universal resource locator (URL) address in a hyperlink. A display module displays a status indicator in response to identifying the uncertain URL address.

### FIELD

The subject matter disclosed herein relates to hyperlink detection and more particularly relates to malicious embedded hyperlink detection.

### BACKGROUND

### Description of the Related Art

Electronic content such as email messages, text messages, web pages, and the like frequently include hyperlinks to additional and/or related information. Unfortunately, some hyperlinks are malicious, linking to unwanted content, viruses, Trojan horses, and the like.

### BRIEF SUMMARY

An apparatus for malicious embedded hyperlink detection is disclosed. The apparatus includes a processor, a memory, an identification module, and a display module. The memory stores machine readable code executable by the processor. The identification module identifies an uncertain universal resource locator address in a hyperlink. The display module displays a status indicator in response to identifying the uncertain URL address. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a drawing illustrating one embodiment of hyperlinks displayed on an electronic device;

FIGS. 2A-D are text illustrations showing embodiments of hyperlinks;

FIGS. 3A-C are drawings illustrating embodiments of hyperlinks displayed with status indicators on electronic devices;

FIG. 4 is a schematic block diagram illustrating one embodiment of hyperlink data;

FIG. 5 is a schematic block diagram illustrating one embodiment of an electronic device;

FIG. 6 is a schematic block diagram illustrating one embodiment of the hyperlink detection apparatus; and

FIG. 7 is a schematic flow chart diagram illustrating one embodiment of a malicious embedded hyperlink detection method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a machine readable signal medium or a storage device. The computer readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wire line, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

Descriptions of Figures may refer to elements described in previous Figures, like numbers referring to like elements.

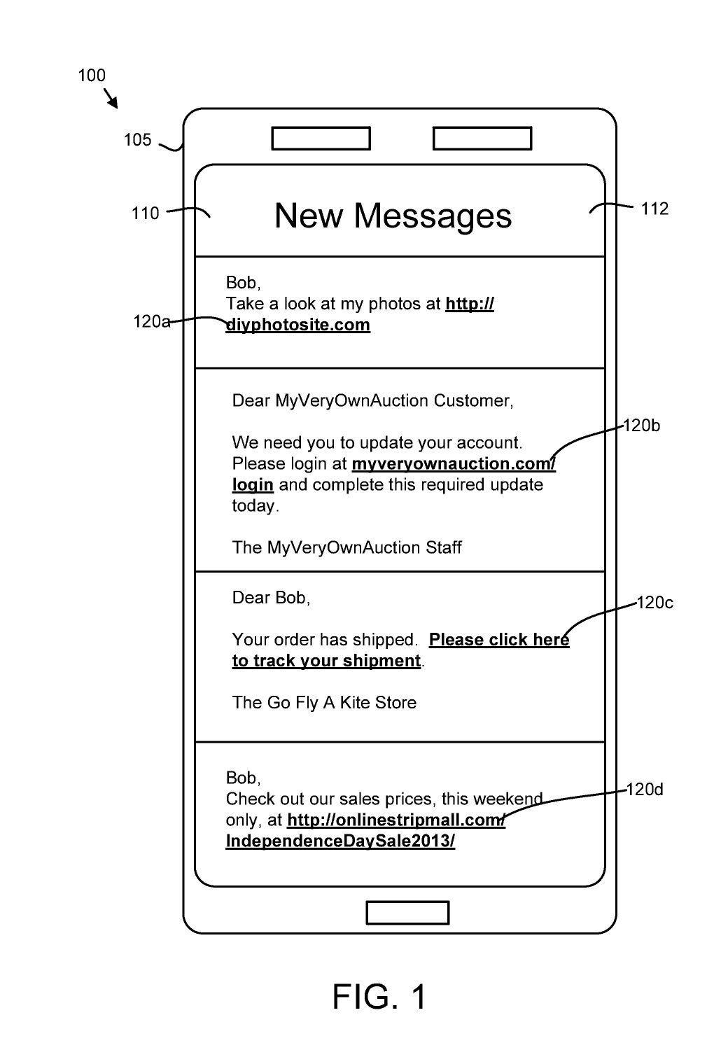

FIG. 1 is a drawing illustrating one embodiment of hyperlinks 120 displayed on an electronic device 105. In the depicted embodiment, the electronic device 105 is a mobile telephone. In alternate embodiments, the electronic device 105 may be a tablet computer, a laptop computer, a table top computer, a computer workstation, and eyeglass computer, a wearable computer, a computer embedded in an automobile and/or appliance, and the like.

The electronic device 105 includes a display 110. The display 110 may be a touch screen. The display 110 may display text, images, video, and combinations thereof. As used herein, the text, images, and video are referred to as display data 112. In the depicted embodiment, the display data 112 comprises a plurality of exemplary messages. Each of the messages includes hyperlinks 120.

In many cases, the hyperlinks 120 serve useful purposes. For example, the hyperlinks 120 may allow a user to easily access additional information by selecting the hyperlink 120. Unfortunately, some hyperlinks 120 may have a malicious intent. For example, a hyperlink 120 may appear to link to a portal that allows the user to login to an account, when in fact the hyperlink 120 links to a fake portal set up to harvest the user's login information so that the user's account may be fraudulently accessed. The hyperlink 120 may connect with a universal resource locator (URL) address that downloads malicious software such as viruses, Trojan horses, spyware, and the like to the electronic device 105.

The embodiments described herein identify an uncertain URL address in a hyperlink 120 and display a warning indicator in response to identifying the uncertain URL address as will be described hereafter. As a result, the user of the electronic device 105 is warned about potentially malicious hyperlinks 120 and can avoid connecting to those hyperlinks 120.

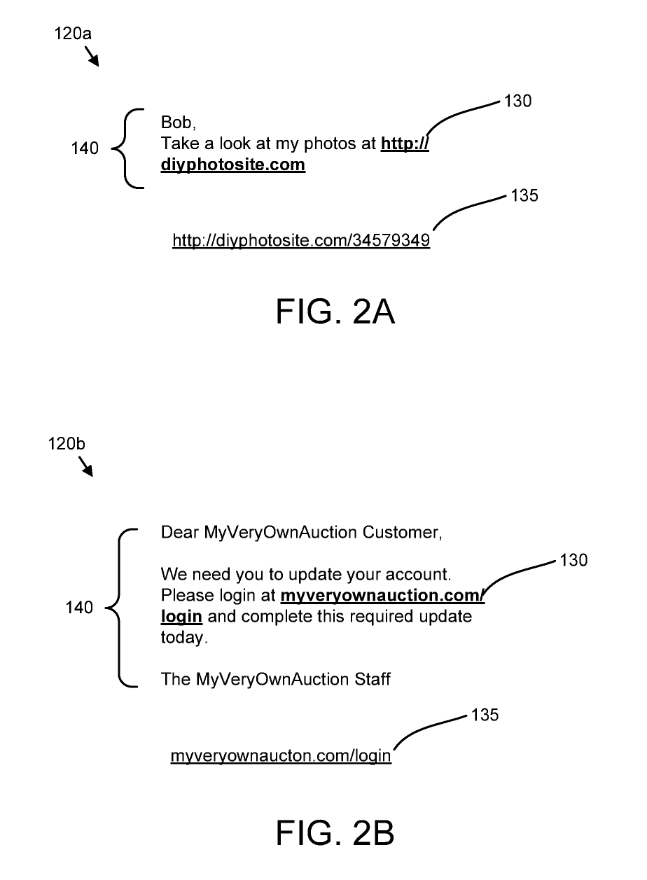

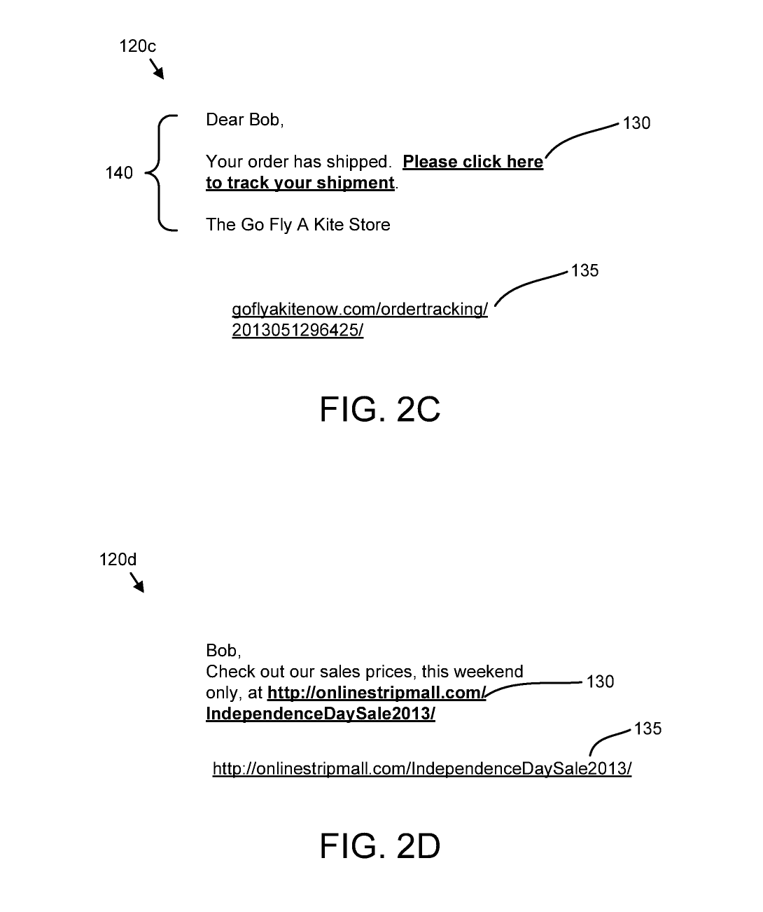

FIGS. 2A-D are text illustrations showing embodiments of hyperlinks 120. The hyperlinks 120 include a hyperlink display 130 and the URL address 135. The hyperlink display 130 is visible to the user on the electronic device 105. The URL address 135 specifies the actual URL that will be accessed if the user selects the hyperlink 120.

FIG. 2A depicts an exemplary first hyperlink 120a with a hyperlink display 130 that is not the same as the URL address 135. The hyperlink display 130 and URL address 135 have the same top-level domain name, “.com,” and the same second-level domain name, “diyphotosite.” However, the URL address includes additional address information, the string “34579349.”

In one embodiment, a URL address 135 is uncertain if the URL address 135 is not an exact match of the hyperlink display 130. As a result, URL address 135 depicted for the first hyperlink 120a is uncertain. In an alternative embodiment, the URL address 135 is uncertain if the URL address 135 does not comprise a minimum threshold of a hyperlink display 130. The minimum threshold may comprise a top-level domain name and a second-level domain name. In this embodiment, the URL address 135 depicted for the first hyperlink 120a is not uncertain as the URL address 135 comprises the minimum threshold of the hyperlink display 130 as the top-level domain name and second-level domain name of the URL address 135 includes the top-level domain name and the second-level domain name of the hyperlink display 135.

FIG. 2B depicts the second hyperlink 120b wherein the second-level domain name of the URL address 135, “myveryownaucton,” does not match the second-level domain name of the hyperlink display 130, “myveryownauction.” In one embodiment, because the URL address 135 is not an exact match of the hyperlink display 130, the URL address 135 is uncertain. In addition, because the URL address 135 does not comprise the minimum threshold of the hyperlink display 130, wherein the minimum threshold comprises a top-level domain name and a second-level domain name, the URL address 135 may also be uncertain.

FIG. 2C depicts an exemplary third hyperlink 120c wherein the hyperlink display 130 does not display any URL information. Instead, the hyperlink display 130 describes the result of selecting the third hyperlink 120c. In one embodiment, the URL address is uncertain if a hyperlink display 130 does not display the minimum threshold of the URL address 135. As a result, the URL address 135 of the third hyperlink 120c may be uncertain as the hyperlink display 130 does not display the minimum threshold of the URL address 135.

FIG. 2D depicts an exemplary fourth hyperlink 120d wherein the URL address 135 is an exact match of the hyperlink display 130. As a result, the URL address 135 is not uncertain.

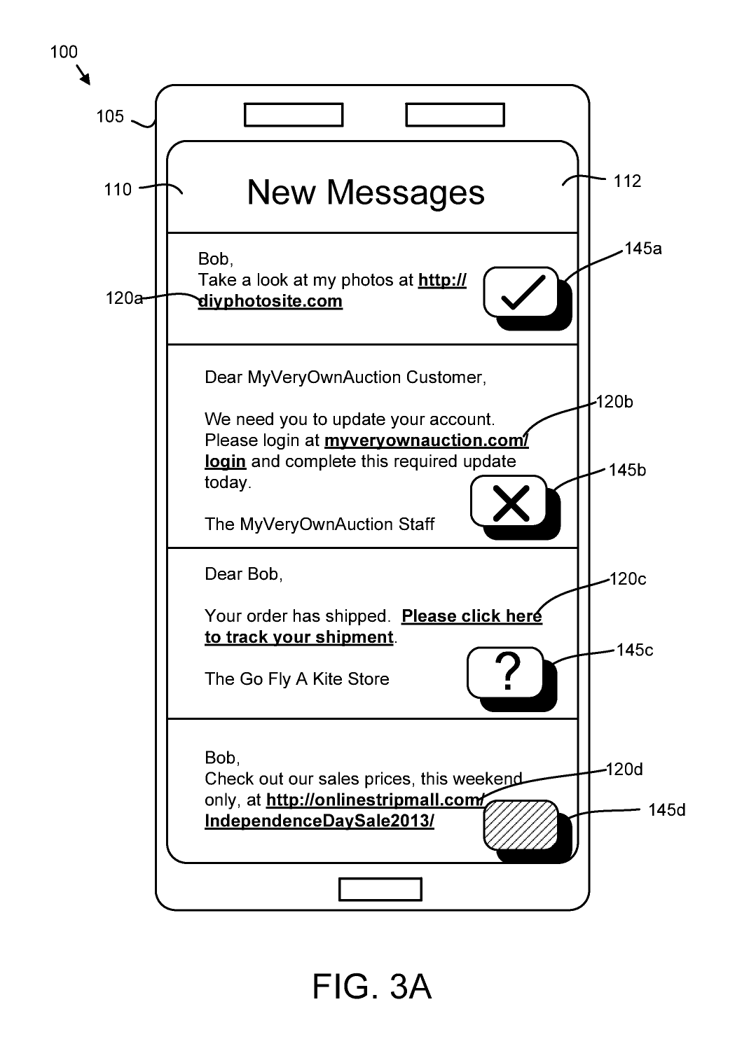

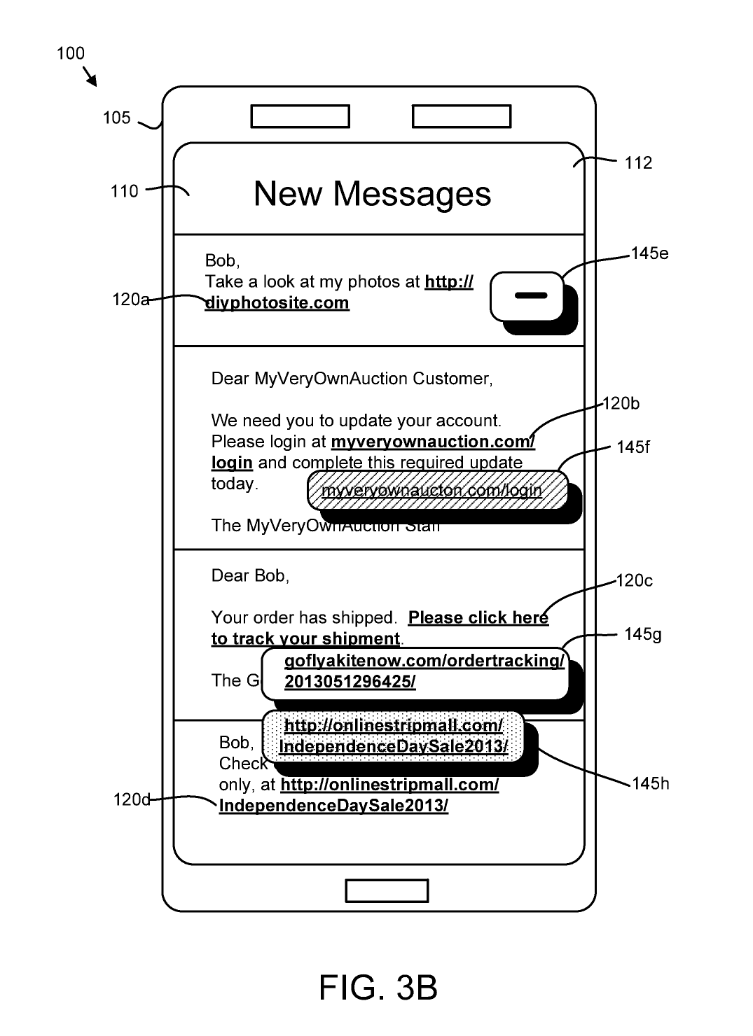

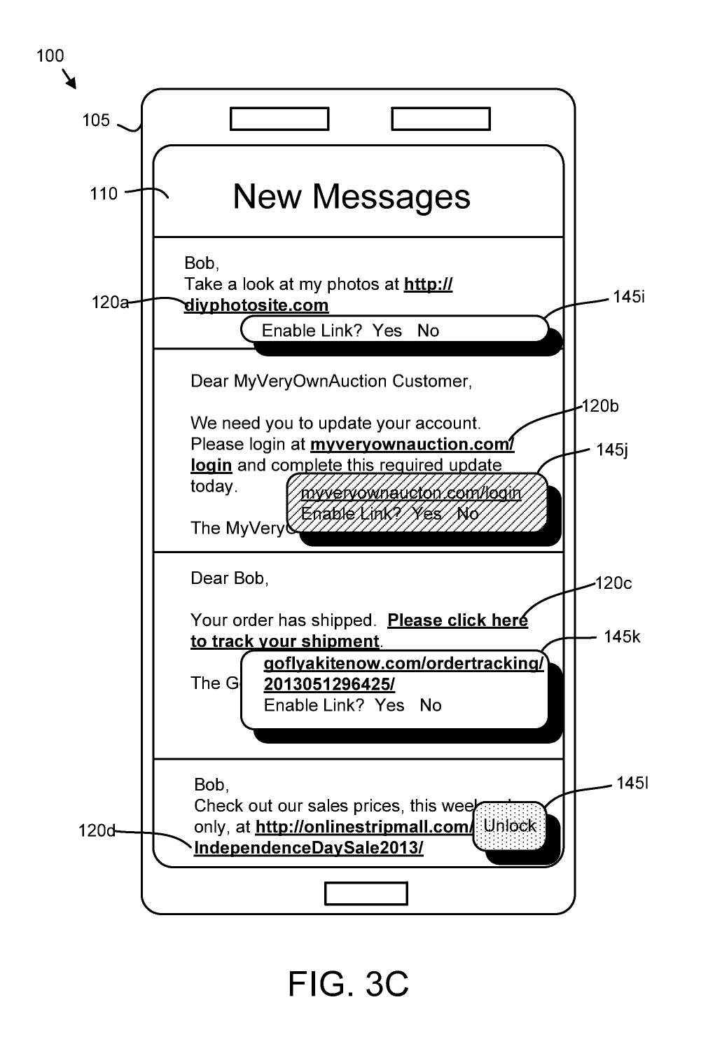

FIGS. 3A-C are drawings illustrating embodiments of hyperlinks 120 displayed with status indicators 145 on electronic devices 105. The display data 112 of FIG. 1 is shown. In addition, status indicators 145 are displayed adjacent to the hyperlinks 120 to indicate a URL address status of the hyperlinks 120.

In one embodiment, the status indicator is selectable to display one or more of the URL address 135 and a URL address status selected from the group consisting of the not uncertain URL address status, the uncertain URL address status, and an indeterminate status. Settings for the electronic device 105 may specify the information communicated in the status indicator 145.

In the FIG. 3A, a no warning status indicator 145a is displayed for the first hyperlink 120a of FIG. 2A. The no warning status indicator 145a may indicate that the first hyperlink 120a has a not uncertain URL address status. The no warning status indicator 145a is shown as a checkmark. The no warning status indicator 145a may indicate that the URL address 135 comprises the minimum threshold of the hyperlink display 130. Alternatively, the no warning status indicator 145a may indicate that the URL address 135 is an exact match for the hyperlink display 130. One of skill in the art will recognize of the no warning status indicator 145a may be depicted with other symbols, colors such as a green color, and the like.

A warning status indicator 145b is displayed for the second hyperlink 120b of FIG. 2B. The warning status indicator 145b may indicate that the second hyperlink 120b has an uncertain URL address status. The warning status indicator 145b is shown as an “X.” one of skill in the art will recognize that other symbols, colors, and the like may be employed for the warning status indicator 145b. The warning status indicator 145b may indicate that the URL address 135 does not comprise the minimum threshold of the hyperlink display 130. Alternatively, the warning status indicator 145b may indicate the URL address 135 is not an exact match for the hyperlink display 130.

An indeterminate status indicator 145c is displayed for the third hyperlink 120c of FIG. 2C. The indeterminate status indicator 145c may indicate that the third hyperlink 120c has an indeterminate URL address status. The indeterminate status indicator 145c is shown as a question mark. In one embodiment, the indeterminate status indicator 145c is displayed for an uncertain URL address 135 if the hyperlink display 130 does not include URL information. In an alternative embodiment, a warning status indicator 145 may be shown if a hyperlink display 130 does not include URL information.

And no warning status indicator 145d is displayed adjacent to the fourth hyperlink 120d of FIG. 2D. The no warning status indicator 145d may indicate a not uncertain URL address status. In one embodiment, the no warning status indicator 145d is always displayed when the URL address 135 is an exact match with the hyperlink display 130. In the depicted embodiment, the no warning status indicator 145d is depicted as crosshatching. The crosshatching may be representative of a color such as green.

In FIG. 3B, an information available status indicator 145e is displayed adjacent to the first hyperlink 120a of FIG. 2A. The information available status indicator 145e may indicate an certain URL address status. Alternatively, the information available status indicator 145e may be displayed for all hyperlinks 120, regardless of whether or not the URL address 135 has an uncertain URL address status. In one embodiment, selecting the information available status indicator 145e results in the display of the URL address 135 for the hyperlink 120 as shown in a warning URL address status indicator 145f, an indeterminate URL address status indicator 145g, and a not uncertain URL address status indicator 145h.

The warning URL address status indicator 145f displays the URL address 135 for the second hyperlink 120b of FIG. 2B. In addition, the warning URL address status indicator 145f may indicate an uncertain URL address status. In the depicted embodiment, the warning URL address status indicator 145f is crosshatched to indicate that the URL address 135 is uncertain. Alternatively, the warning URL address status indicator 145f may blink, have a specified color, have a specified shape, or otherwise indicate to the user that the URL address 135 has an uncertain URL address status.

The indeterminate URL address status indicator 145g displays the URL address 135 for the third hyperlink 120c of FIG. 2C. In the depicted embodiment, the no warning URL address status indicator 145g is not crosshatched to indicate to the URL address 135 has the indeterminate URL address status. Alternatively, the no warning URL address status indicator 145g may have a specified color, have a scrolling brightness, have a specified shape, or may otherwise indicate to the user that the URL address 135 is indeterminate. In one embodiment, an uncertain URL address status is indicated with a first color such as red, indeterminate, an indeterminate URL address status is indicated with the second color such as yellow, and a not uncertain URL address status is indicated with the third color, such as green.

The not uncertain URL address status indicator 145h displays the URL address 135 for the fourth hyperlink address 120d of FIG. 2D. The not uncertain URL address status indicator 145h is shaded to indicate that the not uncertain URL address status. Alternatively, the not uncertain URL address status indicator 145 may have a specified color, a specified shape, be semi transparent, or the like to indicate that the URL address 135 is not uncertain.

As depicted in FIG. 3C, an enable link status indicator 145i is displayed for the first hyperlink 120a of FIG. 2A. The enable link status indicator 145i may be displayed in response to disabling the hyperlink 120. In one embodiment, all hyperlinks 120 are disabled until a warning acknowledgment is received. In the depicted embodiment, the warning acknowledgment is received in response to the user selecting “yes” at the status indicators 145i-k. Alternatively, the warning acknowledgment is received in response to the user selecting the “unlock” option at the enable link no warning status indicator 145l.

In an alternative embodiment, hyperlinks 120 with an uncertain URL address status are blocked. In another embodiment, hyperlinks 120 with an indeterminate URL address status are blocked. The electronic device 105 may only connect to blocked URL addresses 135 in response to receiving the warning acknowledgment.

An enable link warning URL address status indicator 145j is displayed for the second hyperlink 120b of FIG. 2B. The enable link warning URL address status indicator 145j includes the URL address 135 and an interface that allows the user to issue the warning acknowledgment. The interface is depicted as the text “enable link?” followed by “yes” and “no.” The user may issue the warning acknowledgment by selecting “yes” while the user may block a hyperlink 120 such as the second hyperlink 120b by selecting “no.” The enable link warning URL address status indicator 145j is crosshatched to indicate to the URL address 135 has an uncertain URL address status. One of skill in the art will recognize that embodiments may be practiced with the enable link warning URL address status indicator 145j indicating the uncertain URL address status in other ways such as a specified color, specified shape, blinking, and the like.

An enable link no warning URL address status indicator 145k is displayed for the third hyperlink 120c of FIG. 2C. The enable link no warning URL address status indicator 145k includes the URL address 135 and the interface that allows the user to issue the warning acknowledgment. The interface is depicted as the text “enable link?” followed by “yes” and “no.” The user may issue a warning acknowledgment by selecting “yes” while the user may block a hyperlink 120 such as the third hyperlink 120c by selecting “no.” The enable link no warning URL address status indicator 145k is not crosshatched and/or shaded to indicate an indeterminate URL address status. One of skill in the art will recognize that the indeterminate URL address status may be indicated in other ways including but not limited to a specified color, a specified shape, and the like.

An enable link no warning status indicator 145l is depicted adjacent the fourth hyperlink 120d of FIG. 2D. In one embodiment, the enable link no warning status indicator 145l provides an interface that allows the user to issue the warning acknowledgment. The interface is depicted as the text “unlock.” The user may issue a warning acknowledgment by selecting “unlock.” The enable link no warning status indicator 145l may indicate a not uncertain URL address status. Alternatively, the enable link no warning status indicator 145l may indicate the not uncertain URL address status using a specified color, a specified shape, and the like.

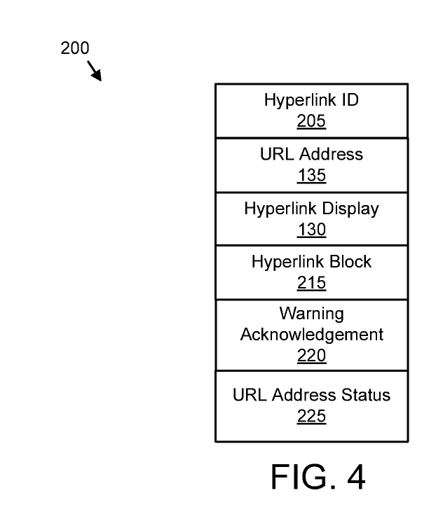

FIG. 4 is a schematic block diagram illustrating one embodiment of hyperlink data 200. The hyperlink data 200 includes a hyperlink identifier 205, the URL address 135, the hyperlink display 130, a hyperlink block 215, the warning acknowledgment 220, and the URL address status 225. The hyperlink data 200 may be stored by the electronic device 105.

The hyperlink data 200 may be created when a hyperlink 120 is detected. In one embodiment, the display data 112 is parsed for hyperlinks 120. Hyperlink data 200 may be created for each hyperlink 120 that is detected.

The hyperlink identifier 205 may uniquely identify each hyperlink 120. The hyperlink identifier 205 may include a logical address of the display data 112 that includes the hyperlink 120, a physical location of the hyperlink 120 on the display 112, and an alphanumeric identifier.

The URL address 135 and the hyperlink display 130 may store the URL address 135 and the hyperlink display 130 parsed from the hyperlink 120. The hyperlink block 215 may indicate whether the URL address 135 may be accessed by the electronic device 105. For example, when the hyperlink block 215 is set, the user may be unable to direct electronic device 105 to connect with the URL address 135.

In one embodiment, the warning acknowledgment 220 is received from the user. If the warning acknowledgment 220 is received, the electronic device 105 may connect to the URL address 135 in response to a selection from the user even if the hyperlink block 215 is set.

The URL address status 225 may specify whether the URL address has an uncertain URL address status, an indeterminate URL address status, and a not uncertain URL address status.

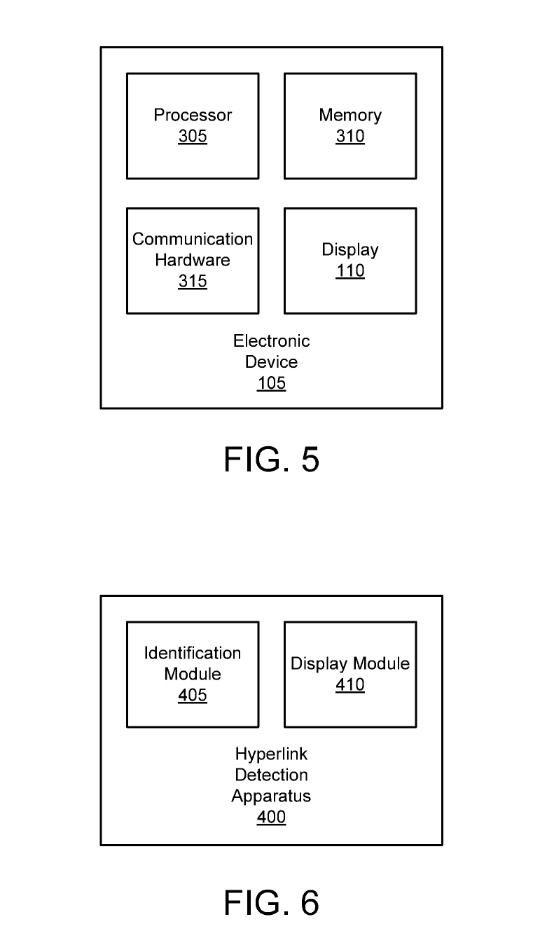

FIG. 5 is a schematic block diagram illustrating one embodiment of the electronic device 105. In addition to the display 110 of FIG. 1, the electronic device 105 includes a processor 305, a memory 310, and communication hardware 315. The memory 310 may be a semiconductor storage device, a hard disk drive, an optical storage device, a micromechanical storage device, or combinations thereof. The memory 310 may store machine readable code. The processor 305 may execute the machine readable code. The communication hardware 315 may communicate with other devices.

FIG. 6 is a schematic block diagram illustrating one embodiment of the hyperlink detection apparatus 400. The apparatus 400 may be embodied in the electronic device 105. The apparatus includes an identification module 405 and a display module 410. The identification module 405 and the display module 410 may be embodied in machine readable code stored by a computer readable storage medium such as the memory 310 and executed by the processor 305.

Identification module 405 may identify an uncertain URL address 135 in a hyperlink 120. The display module 410 may display the status indicator 145 in response to identifying the uncertain URL address 135.

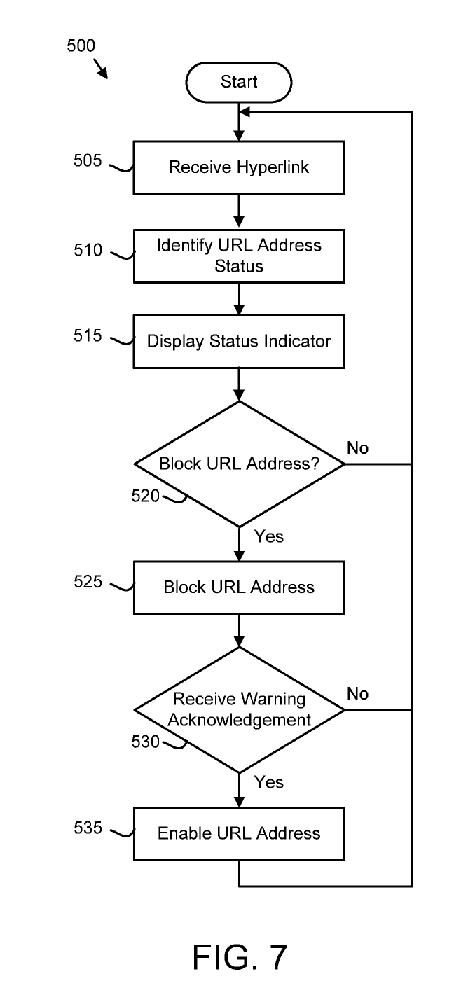

FIG. 7 is a schematic flow chart diagram illustrating one embodiment of a malicious embedded hyperlink detection method 500. The method 500 may perform the function of the electronic device 105 and the apparatus 400. In one embodiment, the method 500 is performed by the processor 305. Alternatively, the method 500 may be performed by a program product comprising a computer readable storage medium, such as the memory 310, storing machine readable code. The machine readable code may be executed by the processor 305 to perform the functions of the method 500.

The method 500 starts, and in one embodiment the identification module 405 receives 505 the hyperlink 120. In one embodiment, the application module 405 may parse the display data 112. The identification module 405 may include a listener that scans all display data 112.

In one embodiment, the identification module 405 receives 505 the hyperlink 120 in response to a touch object hovering at the hyperlink 120. The touch object may be a finger, a stylus, an electronic pen, and the like. The touch object hover may be detected with a capacitive detection, an optical detection, and the like.

The identification module 405 may further identify 510 a URL address status for the URL address 135. In one embodiment, the identification module 405 identifies 510 an uncertain URL address status 225 for the URL address 135. The URL address status 225 for the URL address 135 may be uncertain if the URL address 135 does not display the minimum threshold of the hyperlink display 130. The minimum threshold may comprise a top-level domain name and a second-level domain name. For example, if the top-level domain name and the second-level domain name of the URL address 135 does not include to the top-level domain name and the second-level domain name of the hyperlink display 130, the identification module 405 may identify 510 the URL address status 225 as uncertain.

Alternatively, the URL address status 225 for the URL address 135 is uncertain if the hyperlink display 130 does not display the minimum threshold of the URL address 135. For example, if the hyperlink display 130 does not display the top-level domain name and the second-level domain name of the URL address 135, the identification module 405 may identify 510 URL address status 225 as uncertain.

In one embodiment, the identification module 405 may identify 510 the URL address status 225 as indeterminate if a hyperlink display 130 does not include URL information. In addition, the identification module 405 may identify 510 the URL address status 225 as not uncertain if the URL address 135 comprises a minimum threshold of the hyperlink display 130.

In one embodiment, the URL address status 225 is identified 510 in response to the touch object hovering at the hyperlink 120. For example, the identification module 405 may parse the hyperlink 120 in response to a touch object hover at the hyperlink 120 and identify 510 the URL address status 225.

The display module 410 may display 515 the status indicator 145 for the hyperlink 120. The status indicator 145 may indicate that the URL address 135 has an uncertain URL address status. Alternatively, the status indicator 145 may indicate that the URL address 135 has a not uncertain URL address status. In addition, the status indicator 145 may indicate to the URL address 135 has an indeterminate URL address status.

In one embodiment, the status indicator 145 displays the URL address 135. The status indicator 35 may indicate that the URL address 135 does not match the hyperlink display 130. The status indicator 145 may also present an interface for sending a warning acknowledgement.

The display module 410 may determine 520 whether to block the URL address 135 of the hyperlink 120. The display module 410 may determine 520 to block the URL address 135 in response to a setting of the electronic device 105 and in response to the URL address status 225. In one embodiment, setting specifies that the display module 410 blocks all URL addresses 135. Alternatively, setting may specify that the display module 410 block URL addresses 135 that have uncertain URL address statuses 225 and/or indeterminate URL address statuses 225. In a certain embodiment, the display module 410 blocks URL addresses 135 that have uncertain URL address statuses 225.

If the display module 410 determines 520 not to block the URL address 135, the identification module 405 continues to receive 505 hyperlinks 120. If the display module 410 determines 520 to block the URL address 135, the hyperlink 120 is not enabled and the electronic device 105 will not connect with the URL address 135, even if the hyperlink 120 is selected by the user.

The display module 410 may further determine 530 if the warning acknowledgment 220 is received. In one embodiment, the warning acknowledgment 220 is received by the display module 410 in response to the user selecting the warning acknowledgment from the interface. The interface may be embodied in the status indicator 145. If the warning acknowledgment 220 is not received, identification module 405 continues to receive 505 hyperlinks 120. If the warning acknowledgment is received, the display module 410 does not block the user from accessing the hyper link 120.

By identifying the uncertain URL address 135 and displaying the status indicator indicating the URL address status 225, a user may be warned from selecting potentially malicious hyperlinks 120. In addition, hyperlinks 120 may be blocked unless the user communicates a warning acknowledgment. Thus the user is less likely to direct the electronic device 105 to connect to potentially malicious URL addresses 135.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory storing machine readable code executable by the processor, the machine readable code comprising:
an identification module identifying an uncertain universal resource locator (URL) address in a hyperlink; and
a display module displaying a status indicator in response to identifying the uncertain URL address.

2. The apparatus of claim 1, wherein the URL address is uncertain if the URL address does not comprise a minimum threshold of a hyperlink display.

3. The apparatus of claim 2, wherein the minimum threshold comprises a top-level domain name and a second-level domain name.

4. The apparatus of claim 1, wherein the URL address is uncertain if a hyperlink display does not display a minimum threshold of the URL address.

5. The apparatus of claim 1, wherein the status indicator indicates a not uncertain URL address status in response to the hyperlink comprising a minimum threshold of the URL address, an uncertain URL address status in response to the URL address not comprising the minimum threshold of the hyperlink display, and an indeterminate URL address status in response to the hyperlink display not comprising URL information.

6. A method comprising:
identifying, by use of a processor, an uncertain universal resource locator (URL) address in a hyperlink; and
displaying a status indicator in response to identifying the uncertain URL address.

7. The method of claim 6, wherein the URL address is uncertain if the URL address does not comprise a minimum threshold of a hyperlink display.

8. The method of claim 7, wherein the minimum threshold comprises a top-level domain name and a second-level domain name.

9. The method of claim 6, wherein the URL address is uncertain if a hyperlink display does not display a minimum threshold of the URL address.

10. The method of claim 6, wherein the status indicator displays the URL address.

11. The method of 10, wherein the status indicator indicates that the URL address does not match a hyperlink display.

12. The method of claim 6, wherein the status indicator indicates a not uncertain URL address status in response to the hyperlink comprising a minimum threshold of the URL address, an uncertain URL address status in response to the URL address not comprising the minimum threshold of the hyperlink display, and an indeterminate URL address status in response to the hyperlink display not comprising URL information.

13. The method of claim 6, wherein the status indicator is selectable to display one or more of the URL address and a status selected from the group consisting of a not uncertain URL address status, an uncertain URL address status, and an indeterminate URL address status.

14. The method of claim 6, wherein the uncertain URL address is identified in response to a touch object hover at the hyperlink.

15. The method of claim 6, further comprising blocking the hyperlink if a warning acknowledgement is not received.

16. The method of claim 6, wherein a hyperlink display of the hyperlink is displayed on a touch screen.

17. A program product comprising a computer readable storage medium storing machine readable code executable by a processor to perform:
identifying an uncertain universal resource locator (URL) address in a hyperlink; and
displaying a status indicator in response to identifying the uncertain URL address.

18. The program product of claim 17, wherein the URL address is uncertain if the URL address does not comprise a minimum threshold of a hyperlink display.

19. The program product of claim 18, wherein the minimum threshold comprises a top-level domain name and a second-level domain name.

20. The program product of claim 17, wherein the URL address is uncertain if a hyperlink display does not display a minimum threshold of the URL address.
